(19) United States
(12) Patent Application Publication
(10) Pub. No.: US 2026/0210593 A1
(43) Pub. Date: Jul. 23, 2026

(54) ENERGY OPTIMIZATION HEAT PUMP SYSTEM AND METHOD FOR HYDROGEN PRODUCTION BY WATER ELECTROLYSIS WITH LOW PRESSURE RATIO

(71) Applicant: NORTHWEST ELECTRIC POWER DESIGN INSTITUTE CO., LTD.OF CHINA POWER ENGINEERING CONSULTING GROUP, Xi'an (CN)

(72) Inventors: Xiaohui ZHAO, Xi'an (CN); Runyu WANG, Xi'an (CN); Anming WANG, Xi'an (CN); Lin FU, Xi'an (CN); Qingchuan BAI, Xi'an (CN); Ye QIANG, Xi'an (CN)

(73) Assignee: NORTHWEST ELECTRIC POWER DESIGN INSTITUTE CO., LTD.OF CHINA POWER ENGINEERING CONSULTING GROUP, Xi'an (CN)

(21) Appl. No.: 19/360,717

(22) Filed: Oct. 16, 2025

(30) Foreign Application Priority Data
Jan. 21, 2025 (CN) 202510092647X

(51) Int. Cl. F25B 30/02; C25B 1/04; C25B 9/67; C25B 15/021; C25B 15/08

(52) U.S. Cl. CPC F25B 30/02; C25B 1/04; C25B 9/67; C25B 15/021; C25B 15/08

(57) ABSTRACT

The present disclosure belongs to the technical field of hydrogen production by water electrolysis, and relates to an energy optimization heat pump system and method for hydrogen production by water electrolysis with low-pressure ratio. It includes a hydrogen oxygen gas-liquid separation unit, a heat pump compressor, and an expander. The hydrogen oxygen gas-liquid separation unit is connected to the hydrogen dryer through a hydrogen cooler. The hydrogen oxygen gas-liquid separation unit is connected to the heat pump absorber through a circulating cooling water pipeline, the hydrogen cooler is connected to the refrigerator through a refrigerant pipeline, and the hydrogen dryer is connected to the steam generator through a hot water pipeline and a steam pipeline respectively. The present disclosure is conducive to reducing the pressure ratio of the heat pump compressor, enriching the selection range of heat pump working fluids, and improving the energy utilization rate of the system.

### CROSS-REFERENCE TO RELATED APPLICATIONS

The application claims priority to Chinese patent application No. 202510092647X, filed on Jan. 21, 2025, the entire contents of which are incorporated herein by reference.

### TECHNICAL FIELD

The present disclosure belongs to the technical field of hydrogen production by water electrolysis, and relates to an energy optimization heat pump system and a method for hydrogen production by water electrolysis with a low-pressure ratio.

### BACKGROUND

Hydrogen production by water electrolysis technology is an effective means to improve the utilization rate of new energy power and also a means of energy storage. The energy carrier of this technology is green hydrogen, which can be used as a clean fuel for road transportation, ships, and aerospace.

Hydrogen energy, as a clean and efficient form of energy, has received widespread attention and development worldwide in recent years. As the hydrogen energy industry continues to progress, the construction of hydrogen energy infrastructure is also increasingly improved. Among them, alkaline water electrolyzer is one of the key technologies for hydrogen production by water electrolysis. It occupies an important position in the hydrogen energy industry due to its compact structure, safe and reliable operation, and long service life.

During the operation of the alkaline water electrolyzer, hydrogen and oxygen are generated by water electrolysis. Its hydrogen production efficiency can usually reach higher than 60%, which means that most of the input electricity is effectively converted into hydrogen energy, but at least about 30% of the electricity is still converted into heat energy, causing energy loss in the system. The crude hydrogen and oxygen at the outlet of the electrolyzer need to be cooled by circulating cooling water and separated from gas and liquid before entering the downstream process. Although these treatment processes are necessary, they will also increase the complexity and energy consumption of the system. In addition, the electrolyzed hydrogen needs to go through deoxidation, cooling, drying, and other processes to make the product dew point reach below −50° C. before it can be stored and transported. This process further consumes energy and reduces the efficiency of the entire system.

The heat pump system can be used to recover the heat generated during the electrolysis process and provide steam and cooling capacity for the drying and purification process of hydrogen products. But at the same time, the heat pump system for cooling and heating has the problem of high pressure ratio of the heat pump compressor.

### SUMMARY

The purpose of the present disclosure is to provide an energy optimization heat pump system and method for hydrogen production by water electrolysis with low-pressure ratio to solve the technical problem of high pressure ratio of heat pump compressor in heat pump system for cooling and heating. The present disclosure is conducive to reducing the pressure ratio of heat pump compressor, enriching the selection range of heat pump working fluids, and improving the energy utilization rate of the system.

To achieve the preceding purpose, the present disclosure provides the following technical solutions:

The present disclosure provides an energy optimization heat pump system for hydrogen production by water electrolysis with a low-pressure ratio, including a hydrogen oxygen gas-liquid separation unit, a hydrogen cooler, and a hydrogen dryer connected in sequence;
it further includes a heat pump compressor, a steam generator, an expander, a refrigerator, and a heat pump absorber;
the hydrogen oxygen gas-liquid separation unit is connected to the heat pump absorber through a circulating cooling water pipeline, the hydrogen cooler is connected to the refrigerator through a refrigerant pipeline, and the hydrogen dryer is connected to the steam generator through a hot water pipeline and a steam pipeline respectively;
the outlet of the heat pump compressor is connected to the inlet of the steam generator and the expander in sequence through a hot heat pump working fluid pipeline, and the outlet of the expander is connected to the inlet of the refrigerator, the heat pump absorber, and the heat pump compressor in sequence through a cold heat pump working fluid pipeline;
the hot heat pump working fluid pipeline and the cold heat pump working fluid pipeline are both connected to the regenerator;
on the hot heat pump working fluid pipeline, the regenerator is located between the steam generator and the expander; and
on the cold heat pump working fluid pipeline, the regenerator is located between the heat pump absorber and the heat pump compressor.

Further, the heat pump compressor and the expander are coaxial.

Further, the heat pump compressor and the expander are not coaxial.

Further, it further includes a feed pipeline, an electrolyzer, a crude product pipeline, and a power distribution module. The inlet of the hydrogen oxygen gas-liquid separation unit is connected to the outlet of the electrolyzer through the crude product pipeline, the inlet of the electrolyzer is connected to the feed pipeline, and the electrolyzer is electrically connected to the power distribution module.

Further, the hydrogen oxygen gas-liquid separation unit is provided with a condensate pipeline, and the hydrogen oxygen gas-liquid separation unit is connected to the feed pipeline through the condensate pipeline.

Further, the hydrogen oxygen gas-liquid separation unit is provided with an oxygen pipeline.

Further, it further includes a hydrogen deaerator, and the hydrogen oxygen gas-liquid separation unit is connected to the hydrogen deaerator and the hydrogen cooler in sequence through a hydrogen pipeline.

Further, it further includes a hydrogen downstream unit, and the outlet of the hydrogen dryer is connected to the hydrogen downstream unit.

Further, the heat pump compressor is electrically connected to the power distribution module.

Based on the preceding method, the present disclosure further provides a usage method for an energy optimization heat pump system for hydrogen production by water electrolysis with a low-pressure ratio, including the following steps:

S1, separating hydrogen, oxygen, and water by the hydrogen oxygen gas-liquid separation unit;

S2, cooling the separated hydrogen by the hydrogen cooler, and the cooled hydrogen entering the hydrogen dryer for drying treatment;

S3, during the hydrogen cooling process, the refrigerator providing cooling capacity to the hydrogen cooler through the refrigerant pipeline to cool the hydrogen, and at the same time, the refrigerator transferring the heat released by the refrigerant pipeline to the cold heat pump working fluid pipeline;

S4, during the hydrogen drying process, the steam generator providing high-temperature steam to the hydrogen dryer through the steam pipeline to dry the hydrogen, at the same time, the steam being cooled into hot water in the hydrogen dryer, and the hot water flowing back to the steam generator through the hot water pipeline to be reheated into steam;

S5, using the circulating cooling water pipeline to take away the waste heat generated during hydrogen production by water electrolysis from the hydrogen oxygen gas-liquid separation unit, and using the heat pump absorber to transfer the heat of the circulating cooling water pipeline to the cold heat pump working fluid pipeline;

S6, compressing the heat pump working fluid by the heat pump compressor and sending it to the steam generator through the hot heat pump working fluid pipeline to provide heat energy for the steam generator, and the heat pump working fluid releasing heat in the steam generator and flowing into the expander; and

S7, the expander expanding and working on the inflowing heat pump working fluid and generating cooling capacity, where the expanded heat pump working fluid enters the inlet of the refrigerator, the heat pump absorber, and the heat pump compressor in sequence through the cold heat pump working fluid pipeline to form a heat pump cycle, and the hot heat pump working fluid pipeline heats the heat pump working fluid in the cold heat pump working fluid pipeline through the regenerator.

Compared with the existing art, the present disclosure has the following beneficial effects:

The hydrogen oxygen gas-liquid separation unit of the present disclosure is configured to separate hydrogen, oxygen, and water generated during water electrolysis. The hydrogen cooler is configured to cool the separated hydrogen. The hydrogen dryer is configured to dry the cooled hydrogen. The heat pump compressor compresses the heat pump working fluid and increases its temperature and pressure. The expander is used for the expansion work of the heat pump working fluid, reducing the temperature and pressure of the heat pump working fluid. The circulating cooling water pipeline is configured to take away the heat of the hydrogen oxygen gas-liquid separation unit, and the heat pump absorber is configured to transfer the heat of the circulating cooling water pipeline to the cold heat pump working fluid pipeline to achieve waste heat recovery. The refrigerant pipeline transports the low-temperature refrigerant in the refrigerator to the hydrogen cooler to facilitate cooling of hydrogen. The hot water becomes high-temperature steam after being heated by the steam generator. The high-temperature steam is transported to the hydrogen dryer through the steam pipeline for drying hydrogen. After cooling in the hydrogen dryer, the high-temperature steam is re-input into the steam generator through the hot water pipeline to achieve waste heat recovery. The outlet of the heat pump compressor is connected to the inlet of the steam generator and the expander in turn through the hot heat pump working fluid pipeline. The outlet of the expander is connected to the inlet of the refrigerator, heat pump absorber, and heat pump compressor in turn through the cold heat pump working fluid pipeline to form a heat pump cycle. During the cycle, the heat pump working fluid absorbs the heat of the hydrogen cooler and the hydrogen oxygen gas-liquid separation unit in turn, realizing the reuse and conversion of thermal energy, which is conducive to reducing the compression ratio of the heat pump compressor, improving the energy utilization rate of the system. Prior to the entry of the heat pump working fluid into the heat pump compressor, heat is recovered from the hot heat pump working fluid pipeline through a regenerator. This process elevates the temperature of the working fluid entering the heat pump compressor, reduces the temperature difference required for the heat pump compressor to heat the working fluid to the temperature demanded by the steam generator, facilitates a decrease in the compression ratio of the heat pump compressor, broadens the selection range of available heat pump working fluids, and enhances the overall energy utilization efficiency of the system.

The heat pump compressor and the expander of the present disclosure are coaxial, which is conducive to reducing the overall size and floor space of the system. Moreover, by recovering the shaft work generated by the expander, the dependence of the heat pump compressor on external energy is reduced, thereby improving the energy efficiency of the entire system.

The hydrogen oxygen gas-liquid separation unit of the present disclosure is provided with a condensate pipeline, and the hydrogen oxygen gas-liquid separation unit is connected to the feed pipeline through the condensate pipeline to realize the reuse of materials.

The hydrogen oxygen gas-liquid separation unit of the present disclosure is connected to a hydrogen deaerator and a hydrogen cooler in sequence through a hydrogen pipeline, and the setting of the hydrogen deaerator is conducive to improving the purity of hydrogen.

The method of the present disclosure separates hydrogen, oxygen, and water through a hydrogen oxygen gas-liquid separation unit. The separated hydrogen is cooled by a hydrogen cooler, and the cooled hydrogen enters a hydrogen dryer for drying. During the hydrogen cooling process, the refrigerator provides cooling capacity to the hydrogen cooler through the refrigerant pipeline to cool the hydrogen. Moreover, the refrigerator exchanges the heat derived from the hydrogen in the refrigerant pipeline to the cold heat pump working fluid pipeline to achieve energy recovery. During the hydrogen drying process, the steam generator provides high-temperature steam to the hydrogen dryer through the steam pipeline to dry the hydrogen. At the same time, the steam is cooled into hot water in the hydrogen dryer, and the hot water flows back to the steam generator through the hot water pipeline and is reheated into steam, realizing energy reuse. The circulating cooling water pipeline is configured to take away the heat of the hydrogen oxygen gas-liquid separation unit, and the heat pump absorber is configured to transfer the heat of the circulating cooling water pipeline to the cold heat pump working fluid pipeline, which effectively utilizes the heat generated in the process of hydrogen oxygen liquid separation. Through the cooperation of the circulating cooling water and the heat pump absorber, this part of the heat is transferred to the heat pump system, realizing energy recovery and reuse, and increasing the temperature of the heat pump working fluid before entering the heat pump compressor. It is beneficial to reduce the compression ratio of heat pump compressors. The heat pump working fluid is compressed by the heat pump compressor and sent to the steam generator through the hot heat pump working fluid pipeline to provide heat energy for the steam generator. The heat pump working fluid releases heat in the steam generator and flows into the expander. The expander expands the inflowing heat pump working fluid and generates cooling capacity. The expanded heat pump working fluid enters the inlet of the refrigerator, heat pump absorber, and heat pump compressor in turn through the cold heat pump working fluid pipeline to form a heat pump cycle. The hot heat pump working fluid pipeline heats the heat pump working fluid in the cold heat pump working fluid pipeline through the regenerator, and recovers the heat of the working fluid in the hot heat pump working fluid pipeline through the regenerator, further reducing the compression ratio of the heat pump compressor. It is conducive to enriching the selection range of heat pump working fluid and improving the energy utilization rate of the system. The refrigerator uses the cooling capacity generated by the expander to cool the refrigerant in the refrigerant pipeline and provide cooling capacity for hydrogen cooling.

### BRIEF DESCRIPTION OF DRAWINGS

FIG. 1 is a schematic diagram of an overall structure of the present disclosure.

FIG. 2 is a schematic diagram of the non-coaxial design structure of the heat pump compressor and expander of the present disclosure.

FIG. 3 is a flow chart of the method of the present disclosure.

Reference numerals: 1. feed pipeline; 2. crude product pipeline; 3. circulating cooling water pipeline; 4. oxygen pipeline; 5. hydrogen pipeline; 6. condensate pipeline; 7. hot water pipeline; 8. steam pipeline; 9. refrigerant pipeline; 10. heat pump working fluid loop; 11. electrolyzer; 12. hydrogen oxygen gas-liquid separation unit; 21. hydrogen deaerator; 22. hydrogen cooler; 23. hydrogen dryer; 24. hydrogen downstream unit; 31. heat pump compressor; 32. steam generator; 33. regenerator; 34. expander; 35. refrigerator; 36. heat pump absorber; 41. power distribution module; 101. hot heat pump working fluid pipeline; 102. cold heat pump working fluid pipeline.

### DETAILED DESCRIPTION OF THE EMBODIMENTS

In order to enable those skilled in the art to better understand solutions of the present disclosure, the following will combine the accompanying drawings in the embodiments of the present disclosure to clearly and completely describe the technical solutions in the embodiments of the present disclosure. Obviously, the described embodiments are some but not all embodiments of the present disclosure. Based on the embodiments described in the present disclosure, all other embodiments obtained by those of ordinary skill in the art without creative work are within the scope of protection of the present disclosure.

Moreover, in the description and claims of the present disclosure and preceding drawings, the terms “include” and “have” and any variations thereof are intended to cover non-exclusive inclusions. For example, a process, method, system, product or equipment that includes a series of steps or units is not necessarily limited to clearly listed steps or units, but may include other steps or units that are not clearly listed or inherent to these processes, methods, products or equipment.

The present disclosure is further described in detail below with reference to the accompanying drawings:

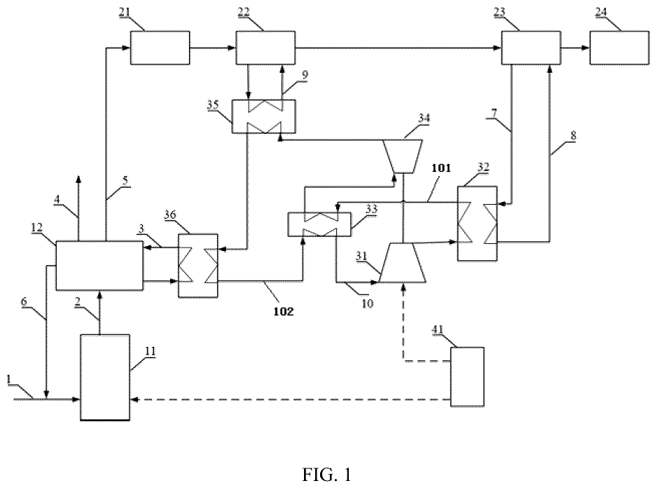

Referring to FIG. 1, the present disclosure provides an optimization heat pump system for hydrogen production energy by water electrolysis with a low-pressure ratio, including a hydrogen oxygen gas-liquid separation unit 12, a hydrogen cooler 22, and a hydrogen dryer 23 connected in sequence; and
it further includes a heat pump compressor 31, a steam generator 32, an expander 34, a refrigerator 35, and a heat pump absorber 36; the hydrogen oxygen gas-liquid separation unit 12 is configured to separate hydrogen, oxygen, and water generated during the water electrolysis. The hydrogen cooler 22 is configured to cool the separated hydrogen. The hydrogen dryer 23 is configured to dry the cooled hydrogen. The heat pump compressor 31 compresses the heat pump working fluid and increases the temperature and pressure of the heat pump working fluid. The expander 34 is configured to expand the heat pump working fluid to do work and reduce the temperature and pressure of the heat pump working fluid.

The hydrogen oxygen gas-liquid separation unit 12 is connected to the heat pump absorber 36 through the circulating cooling water pipeline 3, and the circulating cooling water pipeline 3 is configured to take away the heat of the hydrogen oxygen gas-liquid separation unit 12, and the heat of the circulating cooling water pipeline 3 is transferred to the cold and cold heat pump working fluid pipeline 102 by the heat pump absorber 36, so as to realize the recovery of waste heat. The hydrogen cooler 22 is connected to the refrigerator 35 through a refrigerant pipeline 9, and the refrigerant pipeline 9 transports the refrigerant generated by the refrigerator 35 to the hydrogen cooler 22, which facilitates the cooling of hydrogen. The hydrogen dryer 23 is connected to the steam generator 32 through the hot water pipeline 7 and the steam pipeline 8 respectively; the hot water becomes high-temperature steam after being heated by the steam generator 32, and the high-temperature steam is transported to the hydrogen dryer 23 through the steam pipeline 8 for drying hydrogen. After cooling in the hydrogen dryer 23, the high-temperature steam is re-input into the steam generator 32 through the hot water pipeline 7 to achieve waste heat recovery.

The outlet of the heat pump compressor 31 is connected to the inlets of the steam generator 32 and the expander 34 in sequence through the hot heat pump working fluid pipeline 101, and the outlet of the expander 34 is connected to the inlets of the refrigerator 35, the heat pump absorber 36 and the heat pump compressor 31 in sequence through the cold heat pump working fluid pipeline 102, forming a heat pump cycle. During the cycle, the heat pump working fluid absorbs the heat of the hydrogen cooler 22 and the hydrogen oxygen gas-liquid separation unit 12 in sequence. Realizing the reuse and conversion of thermal energy is conducive to reducing the compression ratio of the heat pump compressor 31 and improving the energy utilization rate of the system. The heat energy generated during water electrolysis and hydrogen cooling can be converted into useful heat energy through the heat pump cycle, thereby reducing overall energy consumption.

The hot heat pump working fluid pipeline 101 and the cold heat pump working fluid pipeline 102 are both connected to the regenerator 33. On the hot heat pump working fluid pipeline 101, the regenerator 33 is located between the steam generator 32 and the expander 34; on the cold heat pump working fluid pipeline 102, the regenerator 33 is located between the heat pump absorber 36 and the heat pump compressor 31. Before the heat pump working fluid enters the heat pump compressor 31, the heat of the working fluid in the hot heat pump working fluid pipeline 101 is recovered by the regenerator 33, which increases the temperature of the working fluid entering the heat pump compressor 31 and reduces the temperature difference required for the heat pump compressor 31 to heat the heat pump working fluid to the steam generator 32, which is conducive to reducing the compression ratio of the heat pump compressor 31. By adding the regenerator 33, the compression ratio of the heat pump compressor 31 of the present disclosure can be reduced to 3.7. It is conducive to enriching the selection range of heat pump working fluids and improving the energy utilization rate of the system. Moreover, the reduction in compression ratio is conducive to reducing the production and manufacturing costs of heat pump compressors and expanders.

### Embodiment 1

Referring to FIG. 1, this embodiment discloses an energy optimization heat pump system for hydrogen production by water electrolysis with a low-pressure ratio, including a hydrogen oxygen gas-liquid separation unit 12, a hydrogen cooler 22, and a hydrogen dryer 23 connected in sequence;
it further includes a heat pump compressor 31, a steam generator 32, an expander 34, a refrigerator 35, and a heat pump absorber 36;
the hydrogen oxygen gas-liquid separation unit 12 is connected to the heat pump absorber 36 through the circulating cooling water pipeline 3; the hydrogen cooler 22 is connected to the refrigerator 35 through the refrigerant pipeline 9, and the hydrogen dryer 23 is connected to the steam generator 32 through the hot water pipeline 7 and the steam pipeline 8 respectively;
the outlet of the heat pump compressor 31 is connected to the inlets of the steam generator 32 and the expander 34 in sequence through the hot heat pump working fluid pipeline 101, and the outlet of the expander 34 is connected to the inlets of the refrigerator 35, the heat pump absorber 36, and the heat pump compressor 31 in sequence through the cold heat pump working fluid pipeline 102;
the hot heat pump working fluid pipeline 101 and the cold heat pump working fluid pipeline 102 are both connected to the regenerator 33;
on the hot heat pump working fluid pipeline 101, the regenerator 33 is located between the steam generator 32 and the expander 34; and
on the cold heat pump working fluid pipeline 102, the regenerator 33 is located between the heat pump absorber 36 and the heat pump compressor 31.

Preferably, on the hot heat pump working fluid pipeline 101, the regenerator 33 is located between the steam generator 32 and the expander 34, which is conducive to recovering the heat of the heat pump working fluid in the hot heat pump working fluid pipeline 101, reducing the difficulty of the expander 34 in depressurizing and cooling the heat pump working fluid, improving the efficiency of the expander 34, and reducing the overall energy consumption of the system.
on the cold heat pump working fluid pipeline 102, the regenerator 33 is located between the heat pump absorber 36 and the heat pump compressor 31. The heat of the high-temperature heat pump working fluid in the hot heat pump working fluid pipeline 101 is transferred to the low-temperature heat pump working fluid in the cold heat pump working fluid pipeline 102, realizing heat recovery and reuse.

Preferably, the heat pump compressor 31 and the expander 34 are coaxial, which is conducive to reducing the overall size and floor space of the system. At the same time, by recovering the shaft work generated by the expander 34, the dependence of the heat pump compressor 31 on external energy is reduced, thereby improving the energy efficiency of the entire system.

Preferably, it further includes a feed pipeline 1, an electrolyzer 11, a crude product pipeline 2 and a power distribution module 41. The inlet of the hydrogen oxygen gas-liquid separation unit 12 is connected to the outlet of the electrolyzer 11 through the crude product pipeline 2, the inlet of the electrolyzer 11 is connected to the feed pipeline 1, and the electrolyzer 11 is electrically connected to the power distribution module 41.

Preferably, the hydrogen oxygen gas-liquid separation unit 12 is provided with a condensate pipeline 6, and the hydrogen oxygen gas-liquid separation unit 12 is connected to the feed pipeline 1 through the condensate pipeline 6 to realize the reuse of materials.

Preferably, the hydrogen oxygen gas-liquid separation unit 12 is provided with an oxygen pipeline 4, and the oxygen pipeline 4 is configured to discharge the oxygen separated by the hydrogen oxygen gas-liquid separation unit 12.

Preferably, it further includes a hydrogen deaerator 21, and the hydrogen oxygen gas-liquid separation unit 12 is connected to the hydrogen deaerator 21 and the hydrogen cooler 22 in sequence through the hydrogen pipeline 5. The setting of the hydrogen deaerator 21 is conducive to improving the purity of hydrogen.

Preferably, it further includes a hydrogen downstream unit 24, and the outlet of the hydrogen dryer 23 is connected to the hydrogen downstream unit 24.

Preferably, the heat pump compressor 31 is electrically connected to the power distribution module 41.

### Embodiment 2

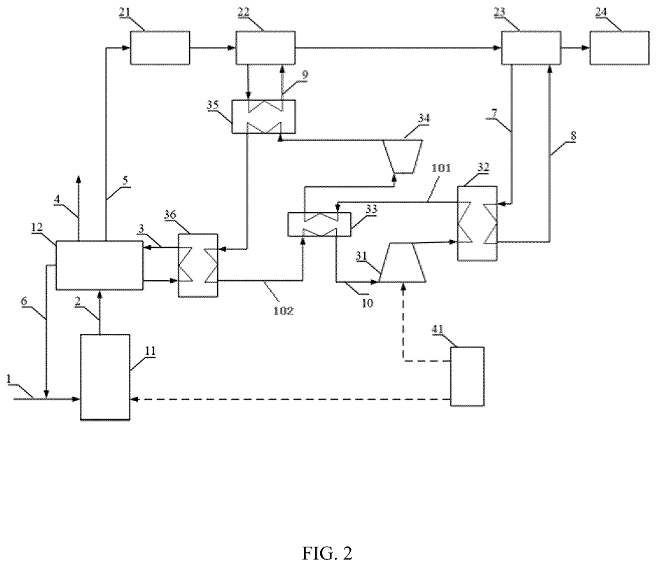

Referring to FIG. 2, this embodiment provides an energy optimization heat pump system for hydrogen production by water electrolysis with a low-pressure ratio. Different from the first embodiment, the heat pump compressor 31 and the expander 34 of this embodiment are not coaxial, that is, the heat pump compressor 31 and the expander 34 are respectively connected to the power distribution module 41 separately, and the heat pump compressor 31 and the expander 34 work independently without interfering with each other. The system can flexibly adjust the power of the heat pump compressor 31 and the expander 34 according to demand, which helps to improve the adaptability and response speed of the system, so that the system can better meet the needs under different environments and working conditions.

### Embodiment 3

Referring to FIGS. 1 and 2, this embodiment provides an energy optimization heat pump system for hydrogen production by water electrolysis with a low-pressure ratio, specifically including a water electrolysis hydrogen production module, a hydrogen drying and purification module, a heat pump module, and a power distribution module 41;
the water electrolysis hydrogen production module includes an electrolyzer 11, a hydrogen oxygen gas-liquid separation unit 12, a feed pipeline 1, a crude product pipeline 2, an oxygen pipeline 4, a hydrogen pipeline 5, and a condensate pipeline 6; the electrolyzer 11 is configured to water electrolysis, the hydrogen oxygen gas-liquid separation unit 12 is connected to the electrolyzer 11, and the hydrogen oxygen gas-liquid separation unit 12 is configured to separate and roughly treat the hydrogen, oxygen, and water generated by the electrolyzer 11;
the hydrogen drying and purification module is connected to the hydrogen oxygen gas-liquid separation unit 12, and the hydrogen drying and purification module includes a hydrogen deaerator 21, a hydrogen cooler 22, a hydrogen dryer 23 and a hydrogen downstream unit 24, and the hydrogen deaerator 21, the hydrogen cooler 22, the hydrogen dryer 23, and the hydrogen downstream unit 24 are connected in sequence;
the heat pump module, the water electrolysis hydrogen production module, and the hydrogen drying and purification module are connected with each other, respectively.
the heat pump module includes a heat pump compressor 31, a steam generator 32, a regenerator 33, an expander 34, a refrigerator 35, and a heat pump absorber 36. The heat pump compressor 31, the steam generator 32, the regenerator 33, the expander 34, the refrigerator 35 and the heat pump absorber 36 are sequentially connected to form a heat pump working fluid loop 10, and the heat pump working fluid circulates in the heat pump working fluid loop 10 in sequence;
the heat pump compressor 31 is configured to compress the heat pump working fluid and increase the temperature and energy quality of the heat pump working fluid;
the steam generator 32 is connected to the hydrogen dryer 23 through the hot water pipeline 7 and the steam pipeline 8;
in the steam generator 32, the hot water of the hot water pipeline 7 absorbs the heat of the heat pump working fluid at the outlet of the heat pump compressor 31 and generates steam, which is configured to provide heat for the hydrogen dryer 23;
the regenerator 33 is used for heat exchange between heat pump working fluids, increasing the temperature of the heat pump working fluid at the inlet of the heat pump compressor 31 and reducing the pressure ratio of the heat pump compressor 31, which is conducive to enriching the selection range of the heat pump working fluid;
the heat pump working fluid loop 10 includes a hot heat pump working fluid pipeline 101 and a cold heat pump working fluid pipeline 102;
the regenerator 33 is connected to the upstream steam generator 32 and the downstream expander 34 respectively through the hot heat pump working fluid pipeline 101, and the regenerator 33 is connected to the upstream heat pump absorber 36 and the downstream heat pump compressor 31 respectively through the cold heat pump working fluid pipeline 102;
the heat pump working fluid is cooled in the regenerator 33 through the hot heat pump working fluid pipeline 101, and the heat pump working fluid is heated in the regenerator 33 through the cold heat pump working fluid pipeline 102 to achieve internal energy recovery;
the expander 34 is configured to expand the heat pump working fluid to do work and generate cold energy;
the refrigerator 35 is connected to the hydrogen cooler 22 through the refrigerant line 9;
in the refrigerator 35, the refrigerant in the refrigerant pipeline 9 absorbs the cold energy of the heat pump working fluid at the outlet of the expander 34, heats the heat pump working fluid, and provides cooling capacity for the hydrogen cooler 22;
the heat pump absorber 36 is connected to the hydrogen oxygen gas-liquid separation unit 12 through the circulating cooling water pipeline 3;
the heat pump absorber 36 further heats the heat pump working fluid at the outlet of the refrigerator 35 through the circulating cooling water in the circulating cooling water pipeline 3, while reducing the temperature of the circulating cooling water, which is configured to provide cooling capacity for the hydrogen oxygen gas-liquid separation unit 12; and
the power distribution module 41 is connected to the water electrolysis hydrogen production module, the hydrogen drying and purification module, and the heat pump module respectively through cables, and provides electric energy for each module.

Referring to FIG. 1, the expander 34 can be coaxial with the heat pump compressor 31 to recover shaft work and save energy consumption of the heat pump compressor 31; and
referring to FIG. 2, the expander 34 and the heat pump compressor 31 may also be arranged non-coaxially.

The beneficial effects of the present disclosure are: through the regenerator 33, heat recovery between heat pump working fluids is achieved, the temperature of the heat pump working fluid entering the heat pump compressor 31 is increased, the pressure ratio of the heat pump compressor 31 to reach the target temperature is reduced, and the equipment load is reduced, which is conducive to enriching the selection range of heat pump working fluids. Moreover, by recovering the waste heat generated in the water electrolysis process, hot water is recovered to produce steam for heating the hydrogen dryer 23, and the waste heat released by hydrogen during the cooling process of the hydrogen cooler 22 is recovered. In addition, hot water is recovered to produce steam for heating the hydrogen dryer 23, thereby improving the energy utilization rate of the system. The present disclosure improves the energy utilization rate of hydrogen production by water electrolysis, reduces operating costs, is conducive to enriching the selection range of heat pump working fluids, and reduces the equipment cost of heat pump compressor 31 and expander 34.

This embodiment takes a 1,000 Nm³/h electrolyzer 11 as an example. After the product produced by the electrolysis of the electrolyzer 11 is transported to the hydrogen oxygen gas-liquid separation unit 12, the circulating cooling water pipeline 3 is configured to take away the heat of the hydrogen oxygen gas-liquid separation unit 12. The flow rate of the circulating cooling water in the circulating cooling water pipeline 3 is 150 t/h, the pressure of the circulating cooling water is 0.4 MPa, and the temperature of the circulating cooling water entering the hydrogen oxygen gas-liquid separation unit 12 is 65° C. The temperature of the circulating cooling water discharged from the hydrogen oxygen gas-liquid separation unit 12 is 80° C., realizing energy recovery. In the prior art, the circulating cooling water needs to be re-cooled to 65° C. by a cooling tower for reuse. The heat in the cooling process of the circulating cooling water is dissipated to the environment, causing waste. The present disclosure uses air as a heat pump working fluid. By consuming an additional 6.17 MW of energy, it can provide cold energy as low as −14.1° C. for the hydrogen cooler 22 and heat energy as high as 315.1° C. for the hydrogen dryer 23. The available energies are 1.94 MW and 10.7 MW, respectively. The energy consumption of the system is saved and the efficiency is significantly improved.

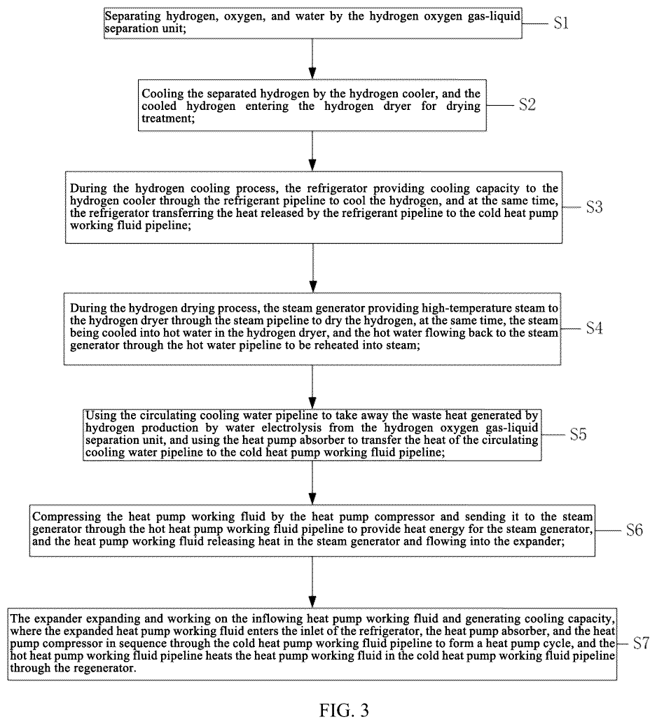

Based on the preceding structure, the present disclosure also discloses a usage method an energy optimization heat pump system for hydrogen production by water electrolysis with a low-pressure ratio, see FIG. 3, including the following steps:

S1, separating hydrogen, oxygen, and water by the hydrogen oxygen gas-liquid separation unit 12;

S2, cooling the separated hydrogen by the hydrogen cooler 22, and the cooled hydrogen entering the hydrogen dryer 23 for drying treatment;

S3, during the hydrogen cooling process, the refrigerator 35 providing cooling capacity to the hydrogen cooler 22 through the refrigerant pipeline 9 to cool the hydrogen, and at the same time, the refrigerator 35 exchanging the heat from the hydrogen in the refrigerant pipeline 9 to the cold heat pump working fluid pipeline 102, thereby realizing energy recovery and utilization, increasing the temperature of the heat pump working fluid before entering the heat pump compressor 31, which is conducive to reducing the compression ratio of the heat pump compressor 31.

S4, during the hydrogen drying process, the steam generator 32 providing high-temperature steam to the hydrogen dryer 23 through the steam pipeline 8 to dry the hydrogen, at the same time, the steam being cooled into hot water in the hydrogen dryer 23, and the hot water flowing back to the steam generator 32 through the hot water pipeline 7 to be reheated into steam, realizing energy reuse and avoiding direct discharge of hot water to waste heat;

S5, using the circulating cooling water pipeline 3 to take away the heat of the hydrogen oxygen gas-liquid separation unit 12, and using the heat pump absorber 36 to transfer the heat of the circulating cooling water pipeline 3 to the cold heat pump working fluid pipeline 102, effectively utilizing the heat generated during the hydrogen oxygen liquid separation process, and transferring this part of the heat to the heat pump system through the cooperation of the circulating cooling water and the heat pump absorber 36, thereby realizing energy recovery and reuse, increasing the temperature of the heat pump working fluid before entering the heat pump compressor 31, being conducive to reducing the compression ratio of the heat pump compressor 31.

S6, compressing the heat pump working fluid by the heat pump compressor 31 and sending it to the steam generator 32 through the hot heat pump working fluid pipeline 101 to provide heat energy for the steam generator 32, and the heat pump working fluid releasing heat in the steam generator 32 and flowing into the expander 34; and

S7, the expander 34 expanding and working on the inflowing heat pump working fluid and generates cooling capacity, where the expanded heat pump working fluid enters the inlet of the refrigerator 35, the heat pump absorber 36 and the heat pump compressor 31 in sequence through the cold heat pump working fluid pipeline 102 to form a heat pump cycle, the hot heat pump working fluid pipeline 101 heats the heat pump working fluid in the cold heat pump working fluid pipeline 102 through the regenerator 33, and recovers the heat of the working fluid in the hot heat pump working fluid pipeline 101 through the regenerator 33, and the compression ratio of the heat pump compressor 31 is further reduced, which is conducive to enriching the selection range of heat pump working fluids and improving the energy utilization rate of the system.

The method of the present disclosure realizes heat recovery between heat pump working fluids through a regenerator 33, and increases the temperature of the heat pump working fluid entering the heat pump compressor 31, and is conducive to reducing the pressure ratio of the heat pump compressor, and is conducive to enriching the selection range of the heat pump working fluid, and at the same time, is conducive to improving the energy utilization rate of the system. Moreover, by recovering the waste heat generated in the water electrolysis process and the waste heat released by hydrogen during the cooling process of the hydrogen cooler 22, the energy utilization rate of the system is improved, the temperature of the heat pump working fluid entering the heat pump compressor 31 is further increased, and the pressure ratio of the heat pump compressor is reduced. In addition, hot water is recovered to produce steam to heat the hydrogen dryer 23, further improving the energy utilization rate of the system.

### Embodiment 4

Referring to FIG. 3, this embodiment discloses a usage method for an energy optimization heat pump system for hydrogen production by water electrolysis with a low-pressure ratio, which is as follows:

The feed pipeline 1 delivers the reactants into the electrolyzer 11, and the power of the electrolyzer is provided by the power distribution module 41;
the crude product after electrolysis is sent to the hydrogen oxygen gas-liquid separation unit 12 through the crude product pipeline 2 for cooling and washing, and hydrogen and water are separated and oxygen and water are separated respectively; the cooling capacity of the hydrogen oxygen gas-liquid separation unit 12 is provided by the circulating cooling water in the circulating cooling water pipeline 3;

The oxygen at the outlet of the hydrogen oxygen gas-liquid separation unit 12 is discharged to the atmosphere through the oxygen pipeline 4 after post-treatment, and the condensed water can be reused. The condensed water is discharged into the feed pipeline 1 through the condensate pipeline 6, and the hydrogen enters the hydrogen deaerator 21, hydrogen cooler 22, hydrogen dryer 23 and hydrogen downstream unit 24 in turn through the hydrogen pipeline 5;
the hydrogen cooler 22 cools the hydrogen to meet the conditions for entering the hydrogen dryer 23, and this part of the cooling capacity is fully or partially provided by the refrigerant in the refrigerant pipeline 9;
the hydrogen dryer 23 dries the hydrogen to meet the conditions for entering the hydrogen downstream unit 24. This part of the heat is fully or partially provided by the steam in the steam pipeline 8. The steam after heating condenses into hot water, which is discharged into the steam generator 32 through the hot water pipeline 7. The hot water pipeline 7 evaporates again in the steam generator 32 and enters the steam pipeline 8;
the heat pump working fluid enters the heat pump compressor 31 through the heat pump working fluid loop 10 for pressurization and heating, and the power of the heat pump compressor 31 is supplied by the power distribution module 41;
the pressurized and heated heat pump working fluid enters the steam generator 32 through the heat pump working fluid loop 10, heats the hot water in the hot water pipeline 7 to boiling point to become steam, and the steam is discharged from the steam pipeline 8;
then the heat pump working fluid enters the regenerator 33 through the heat pump working fluid loop 10 for cooling, and the heat pump working fluid at the outlet of the heat pump absorber 36 is further heated to meet the conditions of the inlet of the heat pump compressor 31;
then the heat pump working fluid enters the expander 34 through the heat pump working fluid loop 10 to expand and do work. In this embodiment, the expander 34 is coaxial with the heat pump compressor 31 to reduce the power consumption of the power distribution module 41;
the heat pump working fluid after being depressurized and cooled in the expander 34 enters the refrigerator 35 through the heat pump working fluid loop 10. The heat pump working fluid cools the refrigerant in the refrigerant pipeline 9 in the refrigerator 35 and increases the temperature of the heat pump working fluid itself;
after the heat pump working fluid passes through the refrigerator 35, it enters the heat pump absorber 36 through the heat pump working fluid loop 10, absorbs the heat of the circulating cooling water in the circulating cooling water pipeline 3, and realizes the cooling of the circulating cooling water; and
after the heat pump working fluid passes through the heat pump absorber 36, the heat pump working fluid enters the regenerator 33 to absorb the heat of the heat pump working fluid at the outlet of the steam generator 32, and further increases the temperature to meet the conditions for entering the heat pump compressor 31.

The above content is only to illustrate the technical idea of the present disclosure, and cannot limit the scope of protection of the present disclosure. Any changes made on the basis of the technical solution in accordance with the technical idea proposed by the present disclosure shall fall within the scope of protection of the claims of the present disclosure.

What is claimed is:

1. An energy optimization heat pump system for hydrogen production by water electrolysis with a low-pressure ratio, comprising a hydrogen oxygen gas-liquid separation unit (12), a hydrogen cooler (22), and a hydrogen dryer (23) connected in sequence;
wherein it further comprises a heat pump compressor (31), a steam generator (32), an expander (34), a refrigerator (35), and a heat pump absorber (36);
the hydrogen oxygen gas-liquid separation unit (12) is connected to the heat pump absorber (36) through a circulating cooling water pipeline (3), the hydrogen cooler (22) is connected to the refrigerator (35) through a refrigerant pipeline (9), and the hydrogen dryer (23) is connected to the steam generator (32) through a hot water pipeline (7) and a steam pipeline (8) respectively;
the outlet of the heat pump compressor (31) is connected to the inlets of the steam generator (32) and the expander (34) in sequence through a hot heat pump working fluid pipeline (101), and the outlet of the expander (34) is connected to the inlets of the refrigerator (35), the heat pump absorber (36) and the heat pump compressor (31) in sequence through a cold heat pump working fluid pipeline (102);
the hot heat pump working fluid pipeline (101) and the cold heat pump working fluid pipeline (102) are both connected to a regenerator (33);
on the hot heat pump working fluid pipeline (101), the regenerator (33) is located between the steam generator (32) and the expander (34); and
on the cold heat pump working fluid pipeline (102), the regenerator (33) is located between the heat pump absorber (36) and the heat pump compressor (31).

2. The energy optimization heat pump system for hydrogen production by water electrolysis with a low-pressure ratio according to claim 1, wherein the heat pump compressor (31) and the expander (34) are coaxial.

3. The energy optimization heat pump system for hydrogen production by water electrolysis with a low-pressure ratio according to claim 1, wherein the heat pump compressor (31) and the expander (34) are not coaxial.

4. The energy optimization heat pump system for hydrogen production by water electrolysis with a low-pressure ratio according to claim 1, wherein it further comprises a feed pipeline (1), an electrolyzer (11), a crude product pipeline (2) and a power distribution module (41); the inlet of the hydrogen oxygen gas-liquid separation unit (12) is connected to the outlet of the electroly zer (11) through the crude product pipeline (2), and the inlet of the electrolyzer (11) is connected to the feed pipeline (1); and the electrolyzer (11) is electrically connected to the power distribution module (41).

5. The energy optimization heat pump system for hydrogen production by water electrolysis with a low-pressure ratio according to claim 4, wherein the hydrogen oxygen gas-liquid separation unit (12) is provided with a condensate pipeline (6), and the hydrogen oxygen gas-liquid separation unit (12) is connected to the feed pipeline (1) through the condensate pipeline (6).

6. The energy optimization heat pump system for hydrogen production by water electrolysis with a low-pressure ratio according to claim 1, wherein an oxygen pipeline (4) is provided on the hydrogen oxygen gas-liquid separation unit (12).

7. The energy optimization heat pump system for hydrogen production by water electrolysis with a low-pressure ratio according to claim 1, wherein it further comprises a hydrogen deaerator (21), and the hydrogen oxygen gas-liquid separation unit (12) is sequentially connected to the hydrogen deaerator (21) and the hydrogen cooler (22) through a hydrogen pipeline (5).

8. An energy optimization heat pump system for hydrogen production by water electrolysis with a low-pressure ratio according to claim 1, wherein it further comprises a hydrogen downstream unit (24), and the outlet of the hydrogen dryer (23) is connected to the hydrogen downstream unit (24).

9. The energy optimization heat pump system for hydrogen production by water electrolysis with a low-pressure ratio according to claim 4, wherein the heat pump compressor (31) is electrically connected to the power distribution module (41).

10. A usage method for an energy optimization heat pump system for hydrogen production by water electrolysis with a low-pressure ratio based on claim 1, comprising the following steps:
S1, separating hydrogen, oxygen, and water by the hydrogen oxygen gas-liquid separation unit (12);
S2, cooling the separated hydrogen by the hydrogen cooler (22), and the cooled hydrogen enters the hydrogen dryer (23) for drying treatment;
S3, during the hydrogen cooling process, the refrigerator (35) providing cooling capacity to the hydrogen cooler (22) through the refrigerant pipeline (9) to cool the hydrogen, and at the same time, the refrigerator (35) transferring the heat released by the refrigerant pipeline (9) to the cold heat pump working fluid pipeline (102);
S4, during the hydrogen drying process, the steam generator (32) providing high-temperature steam to the hydrogen dryer (23) through the steam pipeline (8) to dry the hydrogen, at the same time, the steam being cooled into hot water in the hydrogen dryer (23), and the hot water flowing back to the steam generator (32) through the hot water pipeline (7) to be reheated into steam;
S5, using the circulating cooling water pipeline (3) to take away the waste heat generated during hydrogen production by water electrolysis from the hydrogen oxygen gas-liquid separation unit (12), and using the heat pump absorber (36) to transfer the heat of the circulating cooling water pipeline (3) to the cold heat pump working fluid pipeline (102);
S6, compressing the heat pump working fluid by the heat pump compressor (31) and sending it to the steam generator (32) through the hot heat pump working fluid pipeline (101) to provide heat energy for the steam generator (32), and the heat pump working fluid releasing heat in the steam generator (32) and flowing into the expander (34); and
S7, the expander (34) expanding and working on the inflowing heat pump working fluid and generates cooling capacity, wherein the expanded heat pump working fluid enters the inlet of the refrigerator (35), the heat pump absorber (36) and the heat pump compressor (31) in sequence through the cold heat pump working fluid pipeline (102) to form a heat pump cycle, and the hot heat pump working fluid pipeline (101) heats the heat pump working fluid in the cold heat pump working fluid pipeline (102) through the regenerator (33).
